(19) United States
(12) Patent Application Publication
(10) Pub. No.: US 2010/0254780 A1
(43) Pub. Date: Oct. 7, 2010

(54) Manual perfect binding machine

(76) Inventor: Kirk Lynn Whitham, Fort Collins, CA (US)

Correspondence Address: Kirk Whitham, 409 Baylor Street, Fort Collins, CO, 80525, US

(21) Appl. No.: 12/384,222

(22) Filed: Apr. 2, 2009

(51) Int. Cl. B42C 19/00

(52) U.S. Cl. 412/9

(57) ABSTRACT

A manual perfect binding machine that binds paperback books with hot glue. Pages and a cover are fed under the two clamps on the front of the machine. The front platform is rotated upright to jog the pages. The platform is then rotated horizontally and the pages are secured under the clamps. The cover is scored and a downward clamp is pressed down onto the cover and pages. The front platform is rotated vertically. The uppermost clamp is loosened to allow the glue to penetrate. Glue is applied to the spine, then a leveling guide is moved across the pages, creating a uniform layer of glue on the spine. The front platform is rotated horizontally once more, pressing the glue and spine together. After several seconds, the front platform is rotated vertically. The clamps are loosened and the book is removed. The binding process is complete.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to the perfect binding of paperback books, specifically using common hot glues and other glues to bind books cheaply and efficiently.

2. Prior Art

The perfect binding of books has always been an expensive or slow endeavor. Electrical perfect binders are high priced, overly complicated and require the purchase of specialized glues and supplies specific to particular binding machines. They also require a lot of room to operate and often consume a lot of electricity and generate excessive heat. Hand binding is a laborious task. Layer after layer of glue is applied to the spine of each book, and the glue must dry between applications. And most glues applied by hand remain too flexible and the book spines do not hold up well under repeated readings.

3. Objects and Advantages

The Manual Perfect Binding Machine bridges the gap between the electric binding machines and hand binding. It is simpler to use than electric binders and far more efficient and effective than binding by hand. It uses a common glue gun and common hot glues. The binding machine itself requires no electricity. It does not require much space to operate or store when not in use. Several objects and advantages of the present invention are:
(a) to provide a quick and efficient method of perfect binding that is highly portable. It can easily be transported and set up in a,manner of minutes.
(b) to provide the average person with a simple means of perfect binding. Little skill is required to operate the machine.
(c) to provide a means of binding that requires no exotic or hard-to-find materials. Everything needed to operate the manual binding machine is readily available from common retail sources.
(d) to provide a method that will produce consistent and uniform perfect bound books.

### SUMMARY

In accordance with the present invention the manual binding machine comprises platforms for jogging and clamping unbound pages, two pairs of hinges for rotating platforms, a leveling tool to create a consistent layer of glue, and a downward clamp to provide necessary pressure to the book spine as it is being formed.

### DRAWINGS—FIGURES

FIGS. 1 and 2 show the various parts that comprise the manual binding machine.

FIGS. 1A and 2A show the adjustable downward clamp that provides pressure against the edge of the book spine as it is being bound.

FIGS. 1B and 2B show the front platform where the pages to be bound are placed.

FIG. 2C shows the middle platform.

FIG. 2D shows the back platform.

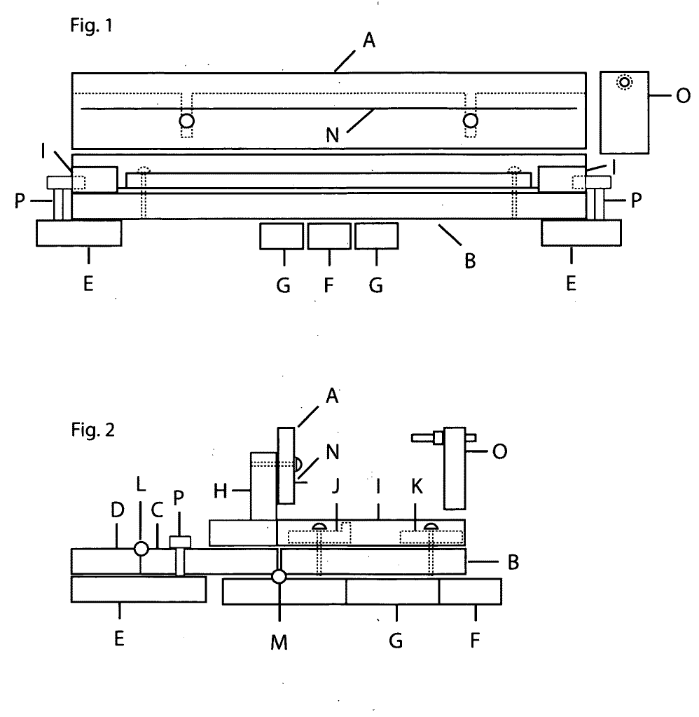

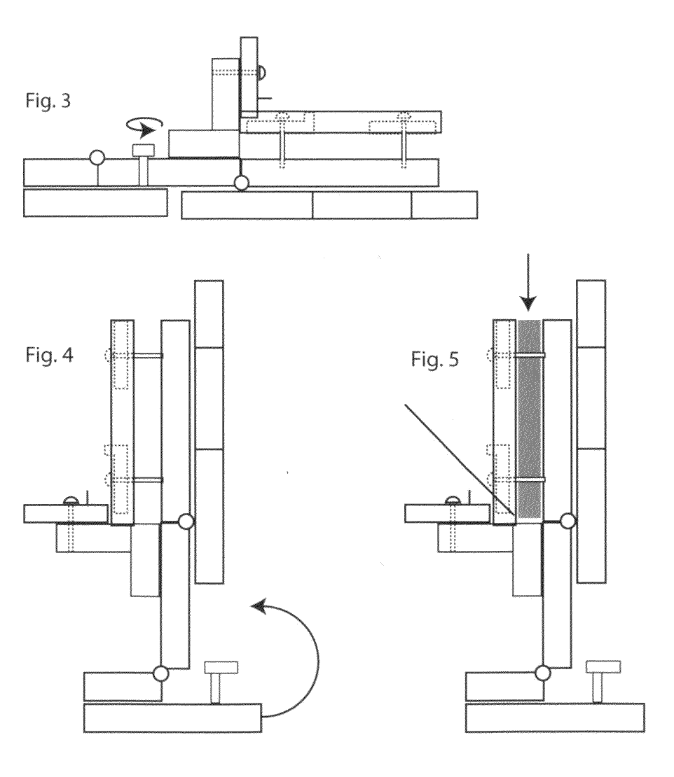

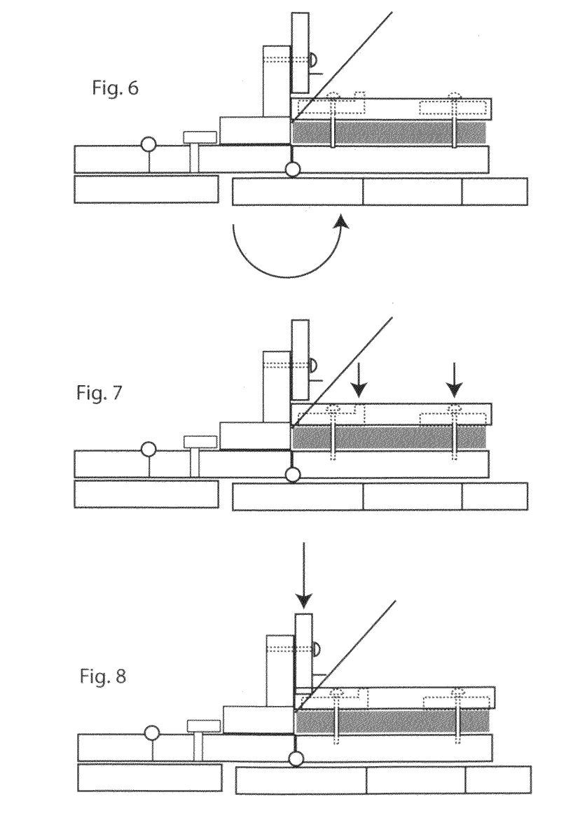

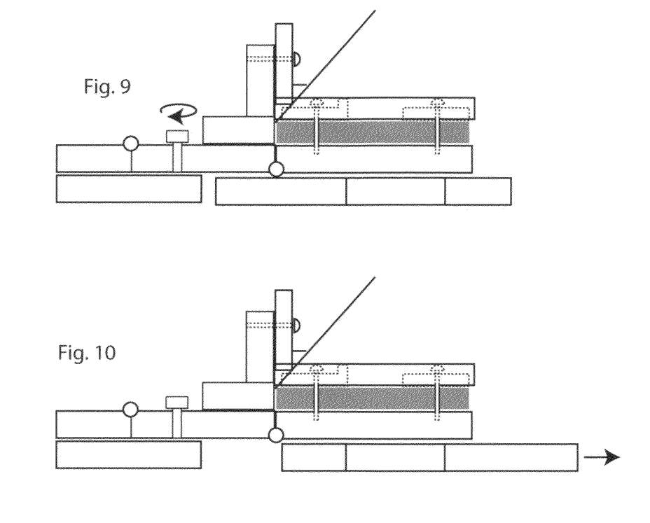

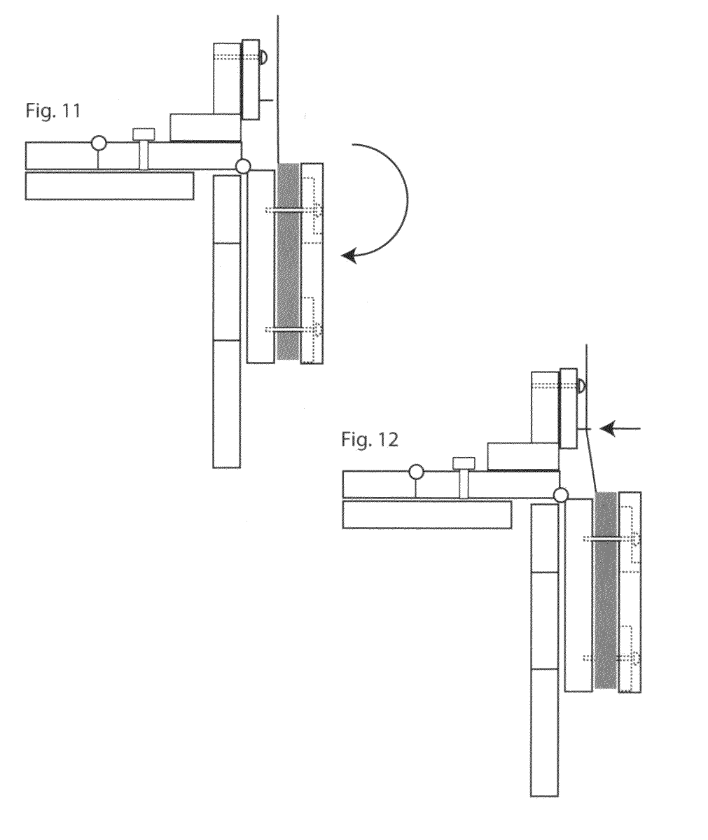

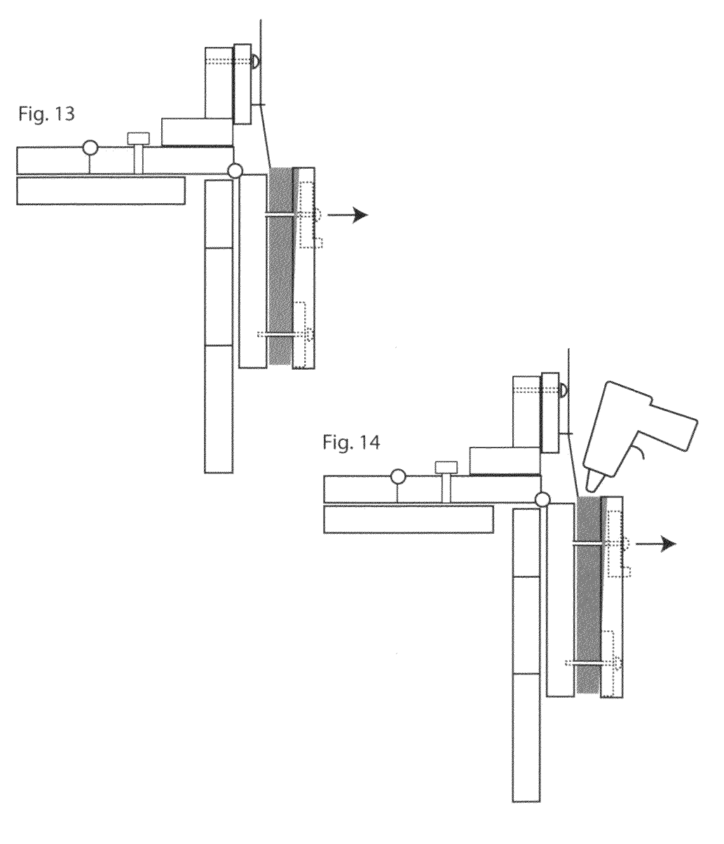

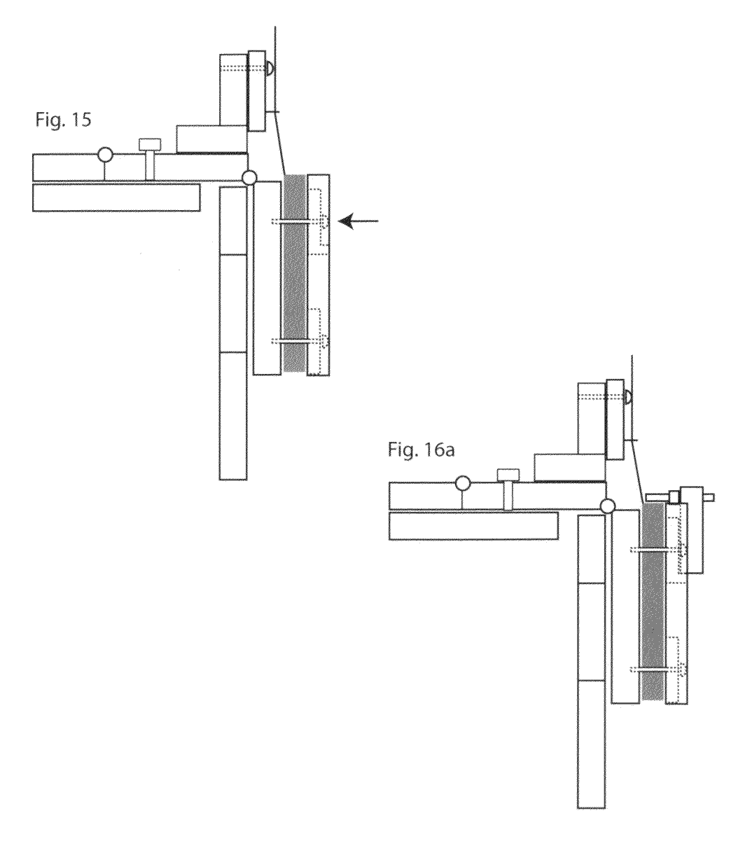

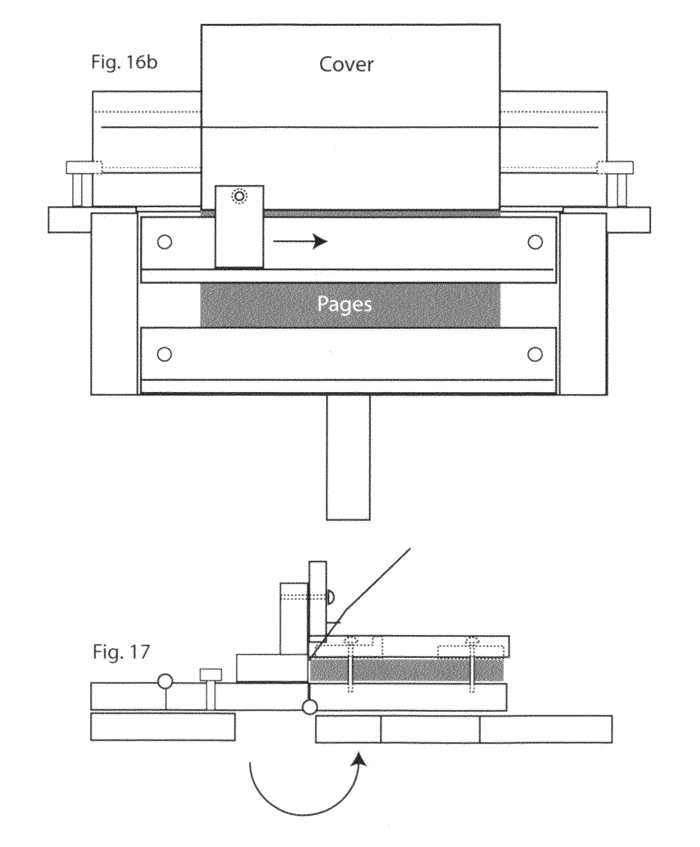

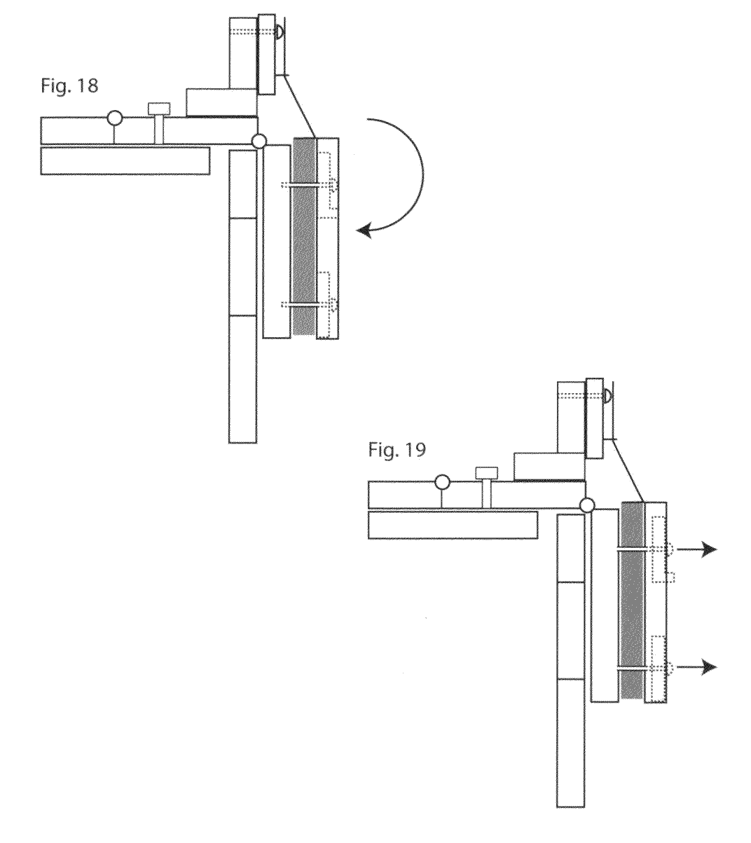

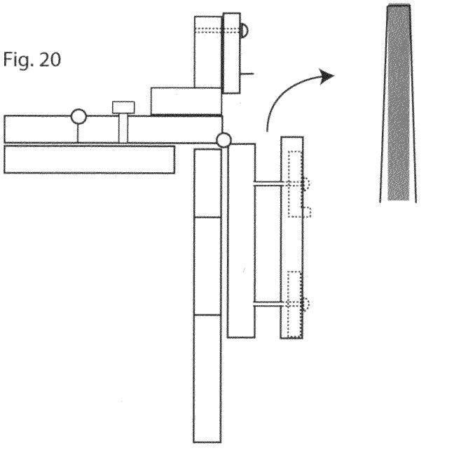

FIGS. 1E and 2E show the platform clamping braces.

FIGS. 1F and 2F show the sliding handle.

FIGS. 1G and 2G show the handle slide guides.

FIG. 2H shows the vertical pressure surface.

FIGS. 1I and 2I show the front platform stop blocks.

FIG. 2J shows the front clamp.

FIG. 2K shows the rear clamp.

FIG. 2L shows the back pivot.

FIG. 2M shows the front pivot.

FIGS. 1N and 2N show the cover holder.

FIGS. 1O and 2O show the glue leveling guide.

FIGS. 1P and 2P show the middle platform lockdown.

### DRAWINGS—REFERENCE NUMERALS

| | | | |
|---|---|---|---|
| 1A & 2A | Downward Clamp | 1B & 2B | Front Platform |
| 2C | Middle Platform | 2H | Upright Support |
| 2J | Front Clamp | 1O & 2O | Glue Leveling Guide |
| 2K | Rear Clamp | 1F & 2F | Sliding Handle |

### DETAILED DESCRIPTION—FIGS. 1 AND 2—PREFERRED EMBODIMENT

A preferred embodiment of the present invention is illustrated in FIG. 1 (front view) and FIG. 2 (side view). The binding machine consists of 3 platforms. The front platform 1B & 2B is the one that holds the pages and cover to be bound. The middle platform 2C, along with the upright support 2H provide a solid surface against which the book spine are merged with the loose pages. The rear platform is mounted to a surface and provides stability to the binder. It also allows the middle and front platforms to rotate to a vertical position so the pages can be properly jogged and settled into the loose spine.

The front clamp 2J locks the loose pages into position and provides a sliding surface for the glue leveling guide 1O & 2O to slide along. The rear clamp 2K provides additional pressure to the pages as the front clamp is loosened during the binding process.

The upright support 2H is mounted to the middle platform. In addition to providing a solid surface against which the spine and book are merged, it is the support for the downward clamp 1A & 2A that compresses the spine during the binding process. The sliding handle 1F & 2F allows for the easy rotation of the front and middle platforms as they are moved into their various binding positions. It slides in and out beneath the front and middle platforms. In its outermost position, the front platform is able to swing down to its vertical orientation.

### OPERATION—FIGS. 3, 4, 5A, 5B, 6

The manner of using the Manual Perfect Binding Machine is different from current methods. The middle platform lockdowns are loosened (FIG. 3). The front and middle platforms are rotated into an upright position. (FIG. 4). The back half of the book cover and the loose pages to be bound are placed on the front platform and beneath the front and rear clamps (FIG. 5).

The front and middle platforms are returned to their horizontal position (FIG. 6). The front and rear clamps are tightened down on the loose pages and the back half of the cover (FIG. 7). The downward clamp is pushed tightly onto the pages as well as both sides of the cover, then locked into position (FIG. 8). This pressure prevents the spine from spreading out when the loose pages are bound to the cover. The platform lockdowns are tightened (FIG. 9).

The sliding handle is pulled back toward the user (FIG. 10). This allows the front platform to swivel to its lower vertical position (FIG. 11). The front half of the cover not placed under the clamps is slid under the cover holder (FIG. 12). This keeps the front half of the cover out of the way of the upcoming glue application. The rear clamp is loosened and the loose pages are allowed to fan out (FIG. 13). Glue is applied to the loose pages (FIG. 14). The front clamp is tightened (FIG. 15). The glue leveling guide is run across the length of the glued pages (FIGS. 16a & 16b). The front platform is lifted into the horizontal position once more (FIG. 17). The glue and pages are merged. Upward pressure on the handle need only be applied for a few seconds.

The platform is lowered once more (FIG. 18). The front and rear clamps are loosened (FIG. 19). The bound book is then removed from the manual perfect binding machine (FIG. 20). This completes the operation.

Accordingly, the reader will see that this method of perfect binding is a simple process that requires no unusual skills. The average person would be able to perfect bind their first book in a manner of minutes after reading the simple instructions. Furthermore, the manual perfect binding machine has the additional advantages in that:
This is an inexpensive method that uses materials easily available to almost everyone.
The ability to loosen the pages while gluing avoids the necessity of grinding pages that other perfect binding machines utilize. The loose page method is a simpler and more elegant solution that is equally effective and requires fewer moving parts.
The small footprint of the manual binding machine makes it easy to store when not in use. No dedicated workspace or electrical outlet is required.
The ease and speed of this type of manual perfect binding allows users to create publications one at a time. If a change in the text of a book or manual is necessary, it can be made without throwing away large numbers of said publication. This will allow true print-on-demand convenience.

I claim:

1. A manual perfect binding machine comprising multiple swiveling platforms, a handle to aid in the swiveling of the platforms, clamps for securing pages and covers to be bound, an upright surface against which the book spine is formed, and a downward clamp to provide compression during the binding process.
